(19) United States
(12) Patent Application Publication
(10) Pub. No.: US 2019/0329148 A1
(43) Pub. Date: Oct. 31, 2019

(54) METHOD FOR HEATING A CONCENTRATE FOR SPRAY DRYING AND AN ASSOCIATED INSTALLATION

(71) Applicant: GEA TDS GmbH, Sarstedt (DE)

(72) Inventors: Uwe Schwenzow, Ahaus (DE); Ulrich Rolle, Everswinkel (DE); Hubert Assing, Ahaus (DE); Ludger Tacke, Velen (DE); Andreas Schmied, Dülmen (DE)

(73) Assignee: GEA TDS GmbH, Sarstedt (DE)

(21) Appl. No.: 16/310,119

(22) PCT Filed: Jun. 14, 2017
(86) PCT No.: PCT/EP2017/000694

§ 371 Date: Dec. 14, 2018

(30) Foreign Application Priority Data
Jun. 23, 2016 (DE) 10 2016 007 636.4

(51) Int. Cl. B01D 1/18; A23L 3/46; A23C 1/04; A23P 10/40; B01D 1/00; B01D 1/20; F26B 3/12; F28D 7/16

(52) U.S. Cl. CPC B01D 1/18; A23L 3/46; A23C 1/04; A23P 10/40; F28D 2021/0042; B01D 1/20; F26B 3/12; F28D 7/1669; A23V 2002/00; B01D 1/0082

(57) ABSTRACT

A method for heating a concentrate in an installation for spray drying comprises increasing a pressure of the concentrate from a low pressure level at a flow temperature to a high pressure level. The concentrate is heated at a high pressure level to a spraying temperature using a high-pressure heat exchanger. The concentrate is shear loaded using a shearing device and immediately transferring the concentrate to a location of pressurized spraying, wherein a transfer time for the immediate transfer is determined by a fluidic effective distance between the shearing device and the location of the pressurized spraying.

### CROSS REFERENCE TO RELATED INVENTION

This application is a national stage application pursuant to 35 U.S.C. § 371 of International Application No. PCT/EP2017/000694, filed on Jun. 14, 2017, which claims priority to German Application 10 2016 007 636.4, filed on Jun. 23, 2016, the entire contents of which are hereby incorporated by reference.

### BACKGROUND

The invention relates to a method for heating a concentrate in an installation for spray drying, in particular for temperature-sensitive concentrates and an installation for performing the method. The invention further relates to a method for controlling the heating of a concentrate in an installation for spray drying. Temperature-sensitive concentrates should be understood in particular as substrates that have a high concentration of proteins and dry material and little water, which are easily denatured and which are processed into a sterile final product during the course of the spray drying under aseptic conditions.

The production of powdered food products, in particular milk products, such as easily soluble food products for small children, takes place in many cases by spray drying in a so-called drying tower. There, a product previously concentrated to a certain concentration of dry substance in a vaporizer or respectively an evaporator and then heated to a defined temperature in a heater, hereinafter referred to as the concentrate, is sprayed into a hot air flow either via disks or, as in the below preferred case, via nozzles, in particular single product nozzles. The concentrate leaving the heater is supplied to these so-called pressurized spray nozzles by means of a high-pressure piston pump, a so-called nozzle pump, with a pressure, which can reach up to max. 350 bar.

The statics of the drying towers are generally insufficient for supporting the heavy high-pressure piston pump and for installing it in the immediate vicinity of the pressurized spray nozzles, which would be desirable for technical and procedural reasons. A high-pressure piston pump arranged in the vicinity of the pressurized spray nozzles would work in this area, the so-called hot area in the head space of the drying tower, at ambient temperatures, which can reach 75 to 80° C., and require an aseptic method of operation. Moreover, a further thermal inactivation of microorganisms would not be possible.

For the aforementioned reasons, the high-pressure piston pump has been arranged up to now in the lower area of the drying tower. A significant height difference between the high-pressure piston pump and the pressurized spray nozzles is bridged via a riser, which also functions according to plan or perforce as a heat-retaining section.

In order to ensure the longest possible and most hygienic storage of the powdered food product, the final product must have a good solubility and must be as sterile as possible. The required sterility results from the killing of microorganisms mainly for the concentrate leaving the heater if it is conveyed with a suitable temperature and dwell time progression and if the riser functioning as the heat-retaining section to the pressurized spray nozzles is taken into account. The production of so-called “low heat powder” requires a temperature of max. 77° C., so-called “high heat powder” requires approx. 85° C. and so-called “ultra high heat powder” requires up to 125° C.

The necessary average dwell time of the concentrate in the riser after the previous high-pressure treatment in connection with a hot temperature impacts the solubility of the final product in an undesired manner. Moreover, the long heat retention in the riser leads to a denaturing of the concentrate. Thus, for example, the average dwell time of the concentrate is 42 seconds if it is conveyed in a 30-meter-long riser with a diameter of DN50 and with a volumetric flow of 5,000 liters/hour. This also generally means a quality reduction of the final product. This type of denaturing can for example impact the powder quality of baby food such that its full solubility is no longer guaranteed and an unacceptable clump formation occurs in the prepared baby food. Moreover, the long dwell time at high temperatures leads to chemical reactions in the concentrate and to the formation of deposits, so-called product fouling, on the walls of the riser and in the pressurized spray nozzles, whereby the production time for a provided charge concentrate is undesirably extended.

For example, for milk concentrates, the temperature in the riser and thus up to the pressurized spray nozzles must not be higher than 65 to 68° C. in order to avoid crystallization processes in the lactose. The long riser thus restricts the permissible temperature there.

An improvement of the microbacterial status of the concentrate before the evaporator, for example through sterilization by means of microfiltration, is known. It is complex but improves the microbacterial status of the final product.

The necessary sterility up to the inlet of the pressurized spray nozzles can also be threatened by the high-pressure piston pump, since it cannot convey the concentrate with justifiable technical effort under aseptic conditions. Aseptic conveyance conditions require in contrast considerable technical effort, which in practice is generally not operated or cannot be operated. Germs from the ambient air can be introduced into the concentrate via the pistons of the high-pressure piston pump so that a reinfection takes place there. The powdered final product can then be contaminated and the contamination will increase depending on time through the effect of the residual moisture notoriously remaining in the final product.

According to the prior art, an aseptic conveyance of the liquid base product leaving the heater is only possible with increased technical effort in the downstream high-pressure piston pump.

The known installations for spray drying, in which a low-pressure heating and subsequent pressure increase in the foot area of the drying tower takes place to a maximum of 350 bar and a conveyance of the concentrate takes place via a riser up to the pressurized spray nozzles, have the following disadvantages: the riser acts like a technologically undesired dwell time section and a heat retainer; the dwell time necessarily reduces the inlet temperature into the pressurized spray nozzles; the dwell time results in an undesired viscosity increase (gelatinization effect); the state of the temperature-sensitive concentrate in front of the pressurized spray nozzles is not clearly defined, because the dwell time in the riser cannot be clearly defined; the dwell time in connection with the heat retention leads to the denaturing of the concentrate, which involves increased concentrate deposits; this results in a shorter service life of the installation, which must thus be cleaned more frequently; the high-pressure piston pump would need to operate in a sterile manner, i.e. the concentrate must be treated aseptically by the pump, which is associated with high costs; high-pressure piston pumps which do not operate aseptically lead to a heavily contaminated final product; and a reduced output of the drying tower results due to the relatively low temperature in front of the pressurized spray nozzles.

In order to achieve the necessary sterility of the liquid concentrate leaving the high-pressure piston pump under a high pressure, a suitable high-pressure heating of the concentrate en route to the pressurized spray nozzles could be provided. This high-pressure heating could take place directly in front of the pressurized spray nozzles, whereby the temperature in the riser could be reduced to a non-critical level. This arrangement would also continue to allow for the operation of a non-aseptically conveying high-pressure piston pump at the foot of the drying tower. In this connection, it was already suggested to perform the high-pressure heating in a sufficiently pressure-resistant, coiled monotube, which is supplied with steam from outside for heating. However, this suggestion is not advantageous, since a uniform heat input via the outside and over the entire length of the monotube and thus an even dwell time for all particles of the concentrate flowing in the monotube is not ensured.

A heat exchanger designed as a monotube is also known from U.S. Pat. No. 3,072,486 A. This publication describes the preparation of soluble milk powder in an installation for spray drying. A concentrate of skim milk or whole milk is preheated in a heating apparatus to a temperature between approximately 40° C. and 49° C., subsequently supplied to a mixer by means of a displacement pump, and then foamed there into a stable foam by supplying a gas. The foam is discharged from the mixer via a pipeline, is supplied to a high-pressure pump, undergoes a pressure increase there to for example approximately 103 bar and exits into a spray dryer at a spray head, which is connected with the high-pressure pump via the pipeline. An end section of the pipeline discharging into the spray head is surrounded by a tube with a larger diameter, which supplies gas heated in an oven to a temperature of approximately 232° C. to the spray head with a temperature between approximately 82° C. and 84° C. The end section of the pipeline transporting the foam thus represents a monotube heated from the outside with a gas.

A heat exchanger, which fulfills the requirements for a sufficiently uniform heat input and for an almost equal dwell time for all particles of the concentrate at a low pressure level, would generally be a so-called shell-and-tube heat exchanger, which could in principle take the place of the aforementioned monotube. The basic structure of this type of shell-and-tube heat exchanger is described for example in DE 94 03 913 U1. DE 10 2005 059 463 A1 also discloses this type of shell-and-tube heat exchanger for a low pressure level and also shows how a number of tube bundles can be arranged parallel in this heat exchanger and connected in series in a fluid-accessible manner by means of connecting elbows or connecting fittings.

Although in the interim a bend or respectively a connecting fitting for product pressures up to 350 bar for connecting the tube bundle in this type of shell-and-tube heat exchanger is available (DE 10 2014 012 279 A1), wherein the known shell-and-tube heat exchanger (DE 94 03 913 U1; DE 10 2005 059 463 A1) is not suitable for this high pressure level, the procedural problem is also not solved, which consists of treating a concentrate for spray drying in front of the pressurized spray nozzles, in which a denaturing of the concentrate and product deposits are avoided and a sterile, i.e. microbiologically perfect final product is guaranteed.

The object of the present invention is thus to overcome the disadvantages of the prior art and to provide a method for heating a concentrate in an installation for spray drying of the generic type and an installation for performing the method, which reduce the tendency toward the denaturing of the concentrate and toward deposits of the same in the case of an economical increase in the output of the drying tower, while ensuring a microbiologically perfect final product.

### BRIEF SUMMARY OF THE INVENTION

The inventive method does not emanate from any relevant prior art, does not require an aseptically functioning high-pressure piston pump to produce a sterile final product, and is characterized by the sequence of the following steps (a) to (d):

(a) Increasing the pressure (P) of the concentrate (K), starting from a low pressure level (p1) and a flow temperature (T1), to a high pressure level (p2),

(b) High-pressure heating (H) of the concentrate (K) at the high pressure level (p2) to an elevated spraying temperature (T3), which lies in the range of 75 to 80° C., by means of a high-pressure heat exchanger, which is supplied on the secondary side with a heat-transfer medium (W) and which is configured as a shell-and-tube heat exchanger having a plurality of inner tubes, through which the concentrate (K) flows in parallel and which are arranged in the shape of a circular ring and on a single circle and which together form an inner channel,

(c) Shear loading (S) of the concentrate (K) in the course of or immediately after the treatment according to step (b) with means that consists of an outlet-side channel having the shape of an annular space, which channel adjoins the inner channel in the flow direction and has a defined extension length and a defined length-dependent progression of its channel passage cross-sections, and

(d) Immediately transferring (0) the concentrate (K) treated according to step (c) to the location of its pressurized spraying (DZ), wherein a transfer time (Δt) for the immediate transfer (U) is determined by a minimum possible fluidic effective distance between the means for performing the step (c) and the location of the pressurized spraying (DZ).

In the case of the method, the heating of the concentrate to an elevated spraying temperature takes place in one step at a high pressure level after the concentrate has first undergone a pressure increasing from a low pressure level to the high pressure level.

In the method, an important inventive fundamental idea is that the concentrate is subjected to a defined shear loading in the course of the high-pressure heating or immediately after the high-pressure heating to the elevated spraying temperature. A defined shear loading shall be understood as a flow-mechanical loading of the concentrate, which exerts shear forces on the concentrate. These shear forces are determined by a defined extension length and a defined length-dependent progression of an outlet-side channel having the shape of an annular space, through which the concentrate must flow, and they can be adjusted for the respective requirements of the concentrate (formulation) though the geometric design of this channel.

This is followed by an immediate transfer of the concentrate to the location of its pressurized spraying. The transfer time for this immediate transfer is set up to be as short as possible. Specifically, as short as possible means that the means for the high-pressure heating, which preferably includes the means for shear loading, receives a minimum possible fluidic effective distance to the location of the pressurized spraying, the pressurized spray nozzles. The means for shear loading preferably flows directly into the pressurized spray nozzles. A fluidic effective distance in this connection means the flow path actually covered by the concentrate.

With the high-pressure heating according to the invention, the increasingly disadvantageous heat retention up to now in the prior art is all but capped and it is possible to define the heating directly in front of the pressurized spray nozzles or respectively to set up the heat treatment in a reproducible manner. Desired heat loads, depending on and adjusted for the concentrate, can be set up in a defined manner for the mass flow and the ingredients. Moreover, a controlled denaturing of the concentrate in light of the desired final product is possible in that the temperature and dwell time are set during the high-pressure heating. An effective microbiological improvement of the final product or a defined protein or starch swelling is thereby achieved.

Through the lower temperature in the riser and the lower dwell time at the high temperature in the course of the high-pressure heating, the viscosity increase in the concentrate, the so-called gelatinization effect, caused by crystallization processes and/or product-specific properties, is lower than in known methods. This gelatinization effect tends to be reduced on one hand by the defined shear loading, and the gelatinization effect is standardized on the other hand, whereby the pressurized spray nozzles first agglutinate much later through the formation of deposits. Cleaning and setup time is thus reduced.

A further advantage of the measures according to the invention is that the concentrate can be supplied with a higher dry material concentration. A dry material increase from 55 to max. 65 mass percent is possible depending on the properties of the concentrate. Mass percent of the concentrate means the ratio in percent, formed from the mass of the concentrate contained in a mass of liquid. The performance of the pressurized spray installation or respectively the drying installation is known to increase with a higher dry material concentration, wherein the spray temperature can be increased by 1 to max. 5° C. with respect to known methods with the same powder quality.

An increase in the temperature of the concentrate leaving the pressurized spray nozzle by 1° C. results in an efficiency increase, i.e. an increase in the output of the drying tower from 2.5 to 3%

$$( \frac{( 2 \text{,} 5 - 3 ) \%}{1 ° C .} ) .$$

The method according to the invention thus decreases the required specific energy for drying and existing drying capacities can be extended.

There exists the possibility of using the method according to the invention introduced here for a UHT treatment of the concentrate up to into the aseptic area with the goal of producing so-called “ultra high heat powder”.

The defined shear loading of the concentrate in the course of or immediately after the high-pressure heating is performed such that the concentrate flows through defined passage cross-sections with defined extension lengths with defined elevated flow speeds. For controlling the defined shear loading, one design of the method provides that an elevated flow speed of the concentrate during the high-pressure heating is increased by 20 to 25% in the treatment area located upstream from the high-pressure heating with respect to its flow speed. In this regard, it is suggested that the elevated flow speed is max. 3 m/s. Since this increase in the flow speed takes place at a high pressure level, the associated additional pressure losses during the high-pressure heating process do not play a significant role.

The elevated flow speed results in a better heat transfer on the concentrate side, which results in the following further advantages: a heat exchange with a lower heat exchanger surface area is possible; a protein concentrate with a higher concentration is possible; a higher volumetric flow and thus a higher output rate are possible; due to the better heat transfer, a higher heating of the concentrate and thereby a higher drying performance are possible; and a defined, systematically desired denaturing of the concentrate takes place.

The method according to the invention provides that the high pressure level to which the concentrate is brought through pressure increasing is max. 350 bar. Furthermore, one design of the method according to the invention provides that the increased spraying temperature lies in the range of 75 to 80° C. and is preferably set here to 80° C. The method further provides a concentrate with a dry material concentration of up to max. 65 mass percent (65 m %).

The installation for performing the method, the fundamental concept of which does not emanate from any closest prior art, consists in order to solve the object according to the invention of a drying tower with pressurized spray nozzles, a feed tank, which is connected in a fluid-accessible manner with the inlet of a high-pressure piston pump via a low-pressure line, in which a feed pump is arranged. A high-pressure heat exchanger is arranged in a high-pressure line connecting in a fluid-accessible manner the outlet of the high-pressure piston pump with the pressurized spray nozzles. The high-pressure heat exchanger is configured as a shell-and-tube heat exchanger having a plurality of inner tubes, through which the concentrate flows in parallel and which are arranged in the shape of a circular ring and on a single circle and which together form an inner channel. The inner channel adjoins the inner tube in the shape of a circumferential annular space in the flow direction. A first high-pressure line section of the high-pressure line connects the outlet of the high-pressure piston pump with the inlet of the high-pressure heat exchanger, and a second high-pressure line section of the high-pressure line connects in a fluid-accessible manner the outlet of the high-pressure heat exchanger with the pressurized spray nozzles.

A fluidic effective length of the second high-pressure line section is reduced to a structurally feasible minimum size, i.e. the outlet of the high-pressure heat exchanger is brought as close as structurally possible to the pressurized spray nozzles, with respect to the flow path of the concentrate.

The high-pressure heat exchanger has means on the outlet side for the defined shear loading of the conveyed concentrate, wherein this means is effective without moving elements and/or the supply of external energy in a purely fluidic manner through defined passage cross-sections, defined lengths of the flow paths and defined elevated flow speeds.

The means for the defined shear loading of the concentrate exists in an outlet-side channel having the shape of an annular space, which is connected on one side with the outlet of the circumferential annular space and on the other side with the second high-pressure line section. The annular-space-shaped, outlet-side channel thereby has in the most general scenario a defined extension length and a defined extension-length-dependent progression of its channel passage cross-sections.

The characteristic with respect to the arrangement of a plurality of inner tubes that are flowed through in parallel should be understood as an arrangement, which, independent of the number of inner tubes, does not occupy an entire circular cross-section of a shell-and-tube heat exchanger. Rather, all inner tubes are arranged on the said single circle, which leaves unoccupied an inner area, not only a delimited center, of inner tubes. This arrangement makes it possible that the inner channel, formed by the inner tubes arranged in the shape of a circular ring and on a single circle in the flow direction, can adjoin the inner tubes in the shape of a circumferential annular space.

In terms of a same dwell time for all parts of the heat-treated concentrate, it is thereby advantageous, as is also suggested, that the channel passage cross-sections are constant over the entire extension length. This desirable equal treatment is further promoted in that the elevated flow speed through the entire shell-and-tube heat exchanger is as uniform as possible up to the end of the defined shear loading of the concentrate, wherein a further embodiment in this respect provides that the channel passage cross-section corresponds with the total passage cross-section of all inner tubes that are flowed through in parallel.

The method according to the invention and the installation for performing the method can be controlled in an advantageous manner depending on the concentrate. For this, the invention suggests a method for controlling the heating of a concentrate in an installation for spray drying. The control parameters for the high-pressure heating are determined by the properties of the concentrate to be heated and the physical edge conditions. The properties of the concentrate to be heated are its volumetric flow, viscosity, pressure, temperature and dry material concentration and the physical edge conditions are the pressure and temperature at the location of the pressurized spraying. The control parameters, respectively relating to the concentrate, are the high pressure level, the elevated spray temperature, the elevated flow speed during the high-pressure heating and the intensity of the shear loading.

The control parameters are set by means of a calibration function saved or generated before or during startup of the installation for spray drying. The calibration function is obtained in that, control parameters of the discussed type are obtained during the startup and retraction of the installation with a discrete concentrate (formulation) until a satisfactory product quality is obtained, they are registered and saved in a controller in the form of a “calibration function” (control parameters=function of (concentrate or respectively formulation)).

During a later treatment of the same concentrate (formulation), these empirical values in the form of this calibration function can be accessed and the necessary control parameters can be appropriately set.

### BRIEF DESCRIPTION OF THE DRAWINGS

A more detailed representation of the invention results from the following description and the attached figures in the drawings as well as from the claims. While the invention is realized in the various designs of a method and in the various embodiments of an installation for performing the method, a known method and, starting from this known method, a preferred design of the inventive method are shown schematically in the drawing. A preferred exemplary embodiment of an installation for performing the method with a high-pressure heat exchanger designed as a shell-and-tube heat exchanger is shown in the drawing and described below. In the figures:

FIG. 1 illustrates a schematic representation of a prior art method for heating a concentrate in an installation for spray drying;

FIG. 1a illustrates a schematic representation of an embodiment of a method for heating a concentrate in an installation for spray drying according to the invention;

FIG. 2 illustrates a schematic representation of a prior art installation for performing the method of FIG. 1;

FIG. 3 illustrates a schematic representation of an installation for performing the method according to FIG. 1a, and

FIG. 4 illustrates a cross-section view of an embodiment of an outlet-side area of a high-pressure heat exchanger configured as a shell-and-tube heat exchanger.

### DETAILED DESCRIPTION OF THE INVENTION

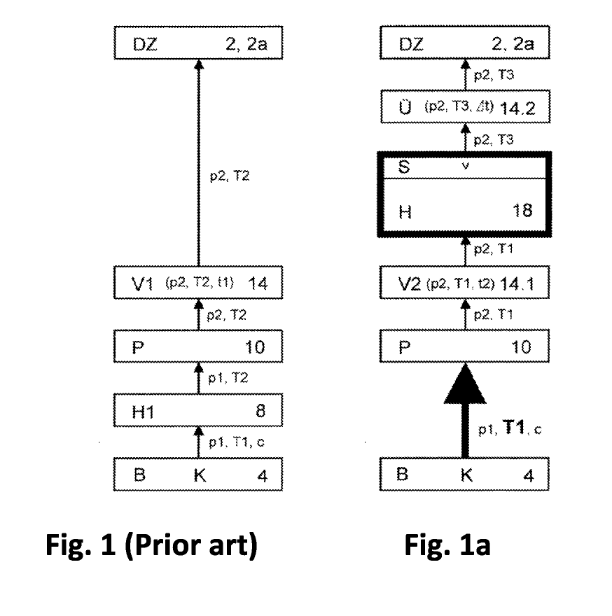

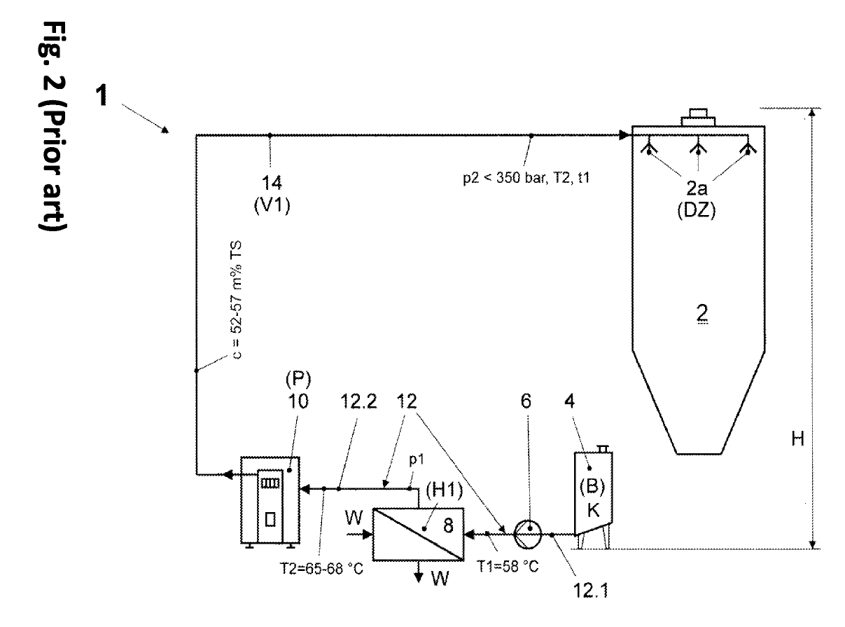

Prior Art (FIGS. 1 and 2)

FIG. 1 shows a method for heating a concentrate K in an installation for spray drying 1 (drying installation) according to the prior art, and FIG. 2 shows an installation 1 according to the prior art for performing the known method. Below, the method and the associated installation 1 are covered in parallel based on these two figures. The named temperatures, pressures and the dry material concentration are selected as examples and can deviate upwards or downwards in practice.

The concentrate K sprayed in a drying tower 2 of the drying installation 1 by a pressurized spraying DZ via pressurized spray nozzles 2a undergoes a stockpiling B in a feed tank 4 (FIGS. 1, 2). The feed tank 4 is connected in a fluid accessible manner via a first line section 12.1 of a low-pressure line 12, in which a feed pump 6 is arranged, with the primary-side inlet of a low-pressure heat exchanger 8, in which a low-pressure heating H1 of the concentrate K from a flow temperature T1=58° C. to an inlet temperature T2=65 to 68° C., which is also still approximately present at the pressurized spray nozzles 2a, is performed. The low-pressure heat exchanger 8 is supplied on the secondary side by means of a heat-transfer medium W, preferably hot water. A high-pressure piston pump 10 is connected on the inlet side via a second line section 12.2 of the low-pressure line 12 with the primary-side outlet of the low-pressure heat exchanger 8 and on the outlet side via a high-pressure line 14 with the pressurized spray nozzles 2a.

In the high-pressure piston pump 10, a pressure increasing P of the concentrate K from a low pressure level p1 present on the inlet side to a high pressure level p2 generated on the output side, which can reach up to p2=max. 350 bar and with which the pressurized spray nozzles 2a are operated minus the drop in pressure up to the latter, takes place. The concentrate K has a dry material concentration c, which can be for example 52 to 57 mass percent (m %) dry material TS.

The drying tower 2 has a tower height H up to into its head area, in which the pressurized spray nozzles 2a are arranged. The high-pressure line 14 mainly overcomes this tower height H in the form of a riser. In the case of a tower height for example of H=30 m, the high-pressure line 14 is also at least 30 m long due to the connection lines located upstream and downstream of the riser. In the case of a diameter DN50 of the high-pressure line 14, a volumetric flow for example of 5,000 liters/hour for a first dwell period V1 of the concentrate K with the inlet temperature T2 at the high pressure level p2 and with the dry material concentration c results in an average first dwell time t1 of 42 seconds. The problems associated with the described method according to the prior art were covered above.

Method and Drying Installation (FIGS. 1a, 3 and 4)

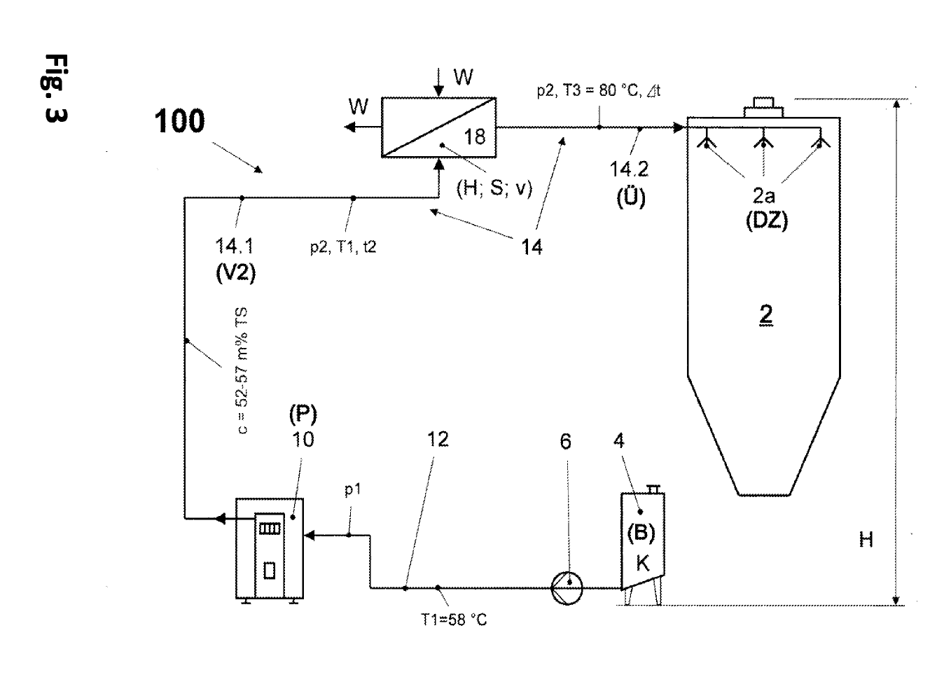

FIG. 1a shows a method according to the invention for heating a concentrate K in an installation for spray drying 100, and FIG. 3 shows an installation 100 according to the invention for performing this method. Below, the method and an associated installation are covered in parallel based on these two figures. The named temperatures, pressures and the dry material concentration are selected as examples and can deviate upwards or downwards in practice.

FIG. 1a obviously shows through thicker lines the differences between the method according to the prior art (FIG. 1) and the method according to the invention, and FIG. 3 shows, based on the drying installation 100, how these differences are realized in terms of the device. In instances where they match, the same references were used. Thus, in order to avoid repetitions, the above description for FIGS. 1 and 2 are referenced.

The high-pressure line 14 (FIG. 3) passes over the primary side of a high-pressure heat exchanger 18, wherein a first high-pressure line section 14.1 of the high-pressure line 14 connects the outlet of the high-pressure piston pump 10 with the inlet of the high-pressure heat exchanger 18, and a second high-pressure line section 14.2 of the high-pressure line 14 connects the outlet of the high-pressure heat exchanger 18 with the pressurized spray nozzles 2a. The high-pressure heat exchanger 18 is supplied on the secondary side with a heat-transfer medium W, preferably hot water. The values selected as examples in FIG. 3 for the low pressure level p1, the high pressure level p2, the flow temperature T1 and the dry material concentration c mainly correspond with those values named in methods according to the prior art and the installation 1 for performing the method (see FIGS. 1, 2).

In the high-pressure heat exchanger 18, a high-pressure heating H of the concentrate K at the high pressure level p2 to an elevated spraying temperature T3, which can lie in the range of 75 to 80° C., takes place (FIG. 3). Furthermore, a defined shear loading S of the concentrate K is provided in the course of or immediately after the high-pressure heating H at an elevated flow speed v (FIGS. 3, 1a). For this, the high-pressure heat exchanger 18 has means on the outlet side for the defined shear loading of the conveyed concentrate K.

Since the high-pressure heat exchanger 18 is arranged at the tower height H (FIG. 3), a second dwell period V2 of the concentrate K with the flow temperature T1 at the high pressure level p2 and with the dry material concentration c with an average second dwell time t2, which is less than the first dwell time t1 and in the case of otherwise almost identical process data is thus less critical, from now on results in the riser between the latter and the outlet of the high-pressure piston pump 10, i.e. in the first high-pressure line section 14.1.

An immediate transfer Ü of the concentrate K treated by defined shear loading S is subsequently performed at the location of its pressurized spraying DZ (FIG. 1a), wherein a transfer time Δt for the immediate transfer Ü is determined by a minimum possible fluidic effective distance between the means for performing the defined shear loading S and the location of the pressurized spraying DZ. The immediate transfer Ü takes place in the correspondingly measured second high-pressure line section 14.2, which is reduced to a structurally feasible minimum size (FIG. 3).

The method according to the invention is distinguished from the method in the prior art, as shown in a comparison of FIG. 1 with FIG. 1a, and FIG. 2 with FIG. 3, in terms of the method by forgoing the low-pressure heating H1 (FIG. 1a) and therefore in terms of the device by forgoing the low-pressure heat exchanger 8 (FIG. 3). The high-pressure heat exchanger 18 has to handle alone a high-pressure heating H of the flow temperature T1 (for example 58° C.) to the elevated spraying temperature T3 (for example max. 80° C.), whereby an increase in the output of the drying tower 2 is achieved without quality losses.

It is critical compared to the method according to the prior art that in the case of the method according to the invention the first high-pressure line section 14.1 mainly formed by the riser is flowed through over its entire length with the flow temperature T1 (for example 58° C.), which is not critical with respect to the inlet temperature T2 (for example 65 to 68° C. in the case of the method according to the prior art). The second retention period V2 of the concentrate K with the flow temperature T1 at the high pressure level p2 and with the dry material concentration c with the average second dwell time t2 is thus completely non-critical from a technical perspective.

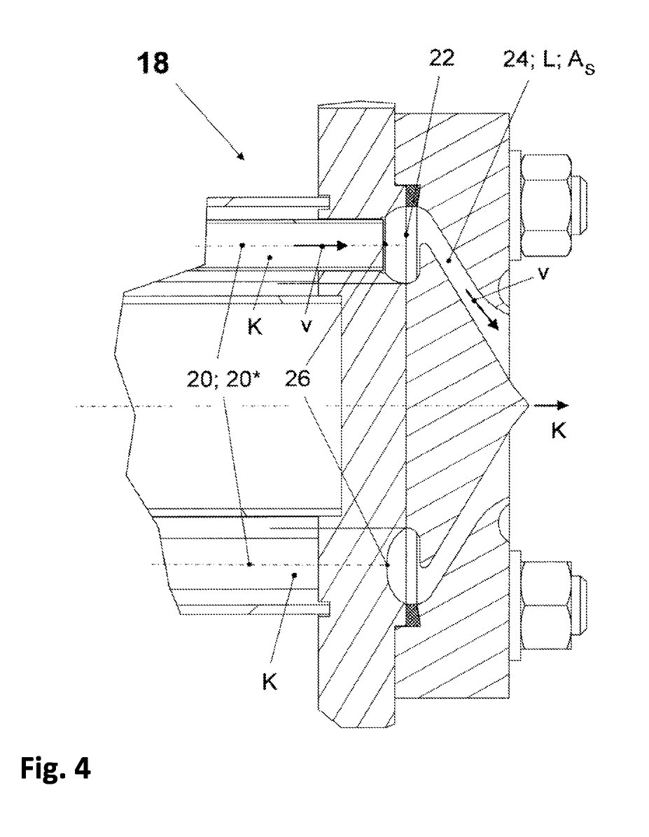

The high-pressure heat exchanger 18 is configured as a shell-and-tube heat exchanger with a plurality of inner tubes 20 (FIG. 4), through which the concentrate K flows in parallel. Referring to FIG. 4, the inner tubes 20 are arranged in the shape of a circular ring and on a single circle 26 and together form an inner channel 20*, which adjoins to the inner tubes (20) in the shape of a circumferential annular space (22) in the flow direction. The means for the defined shear loading of the conveyed concentrate K is arranged on the outlet side on the shell-and-tube heat exchanger 18 and comprises an outlet-side channel 24 having an annular shape that is connected on one side with the outlet of the circumferential annular space 22 and on the other side with the second high-pressure line section 14.2 (FIG. 3). The annular-space-shaped, outlet-side channel 24 has a defined extension length L and a defined length-dependent progression of its channel passage cross-sections AS and, just like the inner tubes 20, is also flowed through by the concentrate K with an elevated flow speed v.

### REFERENCE LIST OF USED ABBREVIATIONS

### FIGS. 1, 2 (Prior Art)

1 Drying installation (installation for spray drying)
2 Drying tower
2a Pressurized spray nozzle
4 Feed tank
6 Feed pump
8 Low-pressure heat exchanger
10 High-pressure piston pump (homogenizer)
12 Low-pressure line
12.1 First line section
12.2 Second line section
14 High-pressure line
H Tower height
c Dry material concentration (in mass percent (m %) dry material (TS))
t1 First dwell time
Temperatures
T1 Flow temperature (approx. 58° C.)
T2 Inlet temperature (approx. 65-68° C.)
Pressures
p1 Low pressure level
p2 High pressure level (<350 bar)
Substances
K Concentrate (product)
TS Dry material
W Heat-transfer medium
Method Steps
B Stockpiling
DZ Pressurized spraying
H1 Low-pressure heating
P Pressure increasing
V1 First dwell period

### FIGS. 1a, 3, 4 (Invention)

100 Drying installation (installation for spray drying)
14.1 First high-pressure line section
14.2 Second high-pressure line section
18 High-pressure heat exchanger (shell-and-tube heat exchanger)
20 Timer tube
20* Inner channel
22 Circumferential annular space
24 Outlet-side channel having an annular-shaped space
26 Circle
AS Channel passage cross-section
L Extension length
t2 Second dwell time
Δt Transfer time
v Elevated flow speed (at H)
Temperature
T3 Elevated spraying temperature (75-80° C.)
Method Steps
H High-pressure heating
S Shear loading
U Immediate transfer
V2 Second dwell period

1-10. (canceled)

11. A method for heating a concentrate (K) in an installation for spray drying, the method comprising:
(a) increasing a pressure (P) of the concentrate (K) from a low pressure level (p1) at a flow temperature (T1) to a high pressure level (p2), wherein the high pressure level (p2) is a maximum of 350 bar;
(b) heating the concentrate (K) at a high pressure level (p2) to a spraying temperature (T3) using a high-pressure heat exchanger, wherein the spraying temperature is 75 to 80° C., and wherein the high-pressure heat exchanger is supplied on a secondary side with a heat-transfer medium (W) comprising a shell-and-tube heat exchanger, the shell-and-tube heat exchanger comprising a plurality of inner tubes configured to direct parallel flows of concentrate (K), wherein the plurality of inner tubes are arranged in a circular ring and on a single circle and together form an inner channel, configured to adjoin the inner tubes in the shape of a circumferential annular space oriented in the flow direction,
(c) shear loading (S) the concentrate (K) using a shearing device comprising an outlet-side channel having the shape of an annular space that is connected on one side with the outlet of the circumferential annular space and on the other side with a second high-pressure line section, wherein the circumferential annular space defines an extension length and a length-dependent progression of its channel passage cross-sections, wherein the shear loading occurs during or immediately after treatment according to step (b); and
(d) immediately transferring (U) the concentrate (K) treated according to step (c) to a location of pressurized spraying (DZ), wherein a transfer time (Δt) for the immediate transfer (U) is determined by a fluidic effective distance between the shearing device and the location of the pressurized spraying (DZ).

12. The method according to claim 11, wherein an elevated flow speed (v) of the concentrate (K) during the heating of the concentrate (K) at the high pressure level (p2) is increased by 20-25% in a treatment area that is positioned upstream from the heating.

13. The method according to claim 12, wherein the elevated flow speed (v) during the heating of the concentrate (K) at the high pressure level (p2) is a maximum of 3 m/s.

14. The method according to claim 11, wherein the spraying temperature (T3) is 80° C.

15. The method according to claim 11, wherein the concentrate (K) is treated with a dry material concentration (c) of up to 65% mass percent (65 m %).

16. The method according to claim 11, wherein control parameters for the heating of the concentrate (K) at the high pressure level (p2) are determined using properties of the concentrate (K) and physical edge conditions.

17. The method according to claim 16, wherein the properties of the concentrate (K) are one or more of volumetric flow of the concentrate (K), viscosity, pressure, temperature, and dry matter concentration, and wherein the physical edge conditions are the pressure and temperature at the location of the pressurized spraying (DZ).

18. The method according to claim 17, wherein the control parameters are the high pressure level (p2), the elevated spray temperature (T3), the flow speed (v) during the heating of the high-pressure concentrate (K) and the intensity of the shear loading (S).

19. The method according to claim 18, wherein the control parameters are set by a calibration function generated before or during startup of installation for spray drying.

20. An installation for spray drying comprising:
a drying tower with pressurized spray nozzles;
a feed tank fluidly connected with an inlet of a high-pressure piston pump via a low-pressure line;
a feed pump is positioned along the low-pressure line;
a first high-pressure line section configured to fluidly couple an outlet of a high-pressure piston pump with an inlet of a high-pressure heat exchanger;
a second high-pressure line section configured to fluidly connect an outlet of the high-pressure heat exchanger to one or more pressurized spray nozzles, wherein a fluidic effective length of the second high-pressure line section is reduced to a structurally feasible minimum size, wherein the high-pressure heat exchanger is a shell-and-tube heat exchanger comprising a plurality of inner tubes through which a concentrate flows in parallel, wherein the plurality of inner tubes are arranged in a circular ring and on a single circle and configured to form an inner channel, and wherein the inner channel is configured to adjoin to the inner tubes in the shape of a circumferential annular space in a flow direction; and
a means for shear loading the concentrate (K) is located on an outlet side on the high-pressure heat exchanger and comprises an outlet-side channel comprising an annular-shaped space that is connected on one side with the outlet of a circumferential annular space and on another side with the second high-pressure line section, wherein the outlet-side channel comprises a defined extension length and a defined length-dependent progression of its channel passage cross-sections (AS).

21. The installation according to claim 20, wherein the channel passage cross-sections (AS) are constant over the entire extension length (L).

22. The installation according to claim 21, wherein the channel passage cross-section (AS) corresponds with a total passage cross-section of all inner tubes that are flowed through in parallel.
